(19) United States
(12) Patent Application Publication
(10) Pub. No.: US 2008/0032179 A1
(43) Pub. Date: Feb. 7, 2008

(54) SEALING STRUCTURE OF COOLING PLATE FOR FUEL CELL STACK

(75) Inventors: Tae-won Song, Yongin-si (KR); Seung-Jae Lee, Yongin-si (KR); Jie Peng, Yongin-si (KR); Jae-young Shin, Yongin-si (KR)

Correspondence Address: STEIN, MCEWEN & BUI, LLP, 1400 EYE STREET, NW, SUITE 300, WASHINGTON, DC, 20005, US

(73) Assignee: Samsung SDI Co., Ltd., Suwon-si (KR)

(21) Appl. No.: 11/627,644

(22) Filed: Jan. 26, 2007

(30) Foreign Application Priority Data
Aug. 1, 2006 (KR) 2006-72662

(51) Int. Cl. H01M 2/08; H01M 8/04

(52) U.S. Cl. 429/35; 429/26

(57) ABSTRACT

A sealing structure for a cooling plate of a fuel cell. The sealing structure includes grooves formed on corresponding regions of a separator of a unit cell and a cooling plate, a first sealing member formed between the grooves, second sealing members formed on each bottom of the grooves, and a third sealing member formed about the first sealing member.

### CROSS-REFERENCE TO RELATED APPLICATIONS

This application claims the benefit of Korean Application No. 2006-72662, filed Aug. 1, 2006, in the Korean Intellectual Property Office, the disclosure of which is incorporated herein in its entirety by reference.

### BACKGROUND OF THE INVENTION

1. Field of the Invention

Aspects of the present invention relate to a sealing structure of a cooling plate used for a high temperature fuel cell stack.

2. Description of the Related Art

A fuel cell is an electricity generating system that transforms chemical energy of oxygen and hydrogen contained in a hydrocarbon group of materials such as methanol, ethanol, or a natural gas directly into electrical energy. Fuel cells may be classified according to the type of electrolyte used. Such classifications include phosphoric acid fuel cells (PAFCs), molten carbonate fuel cells (MCFCs), solid oxide fuel cells (SOFCs), alkali fuel cells (AFCs), or polymer electrolyte membrane fuel cells (PEMFCs). These fuel cells operate according to the same principles but use different fuels, catalysts, and electrolytes. Also, the different fuel cells maintain different operating temperatures.

A PEMFC has higher energy output, lower operating temperature, and starts and responds to changes more quickly than the other types of fuel cells. Therefore, the PEMFC can be applied to various fields such as a mobile power source for an automobile, a distribution power source for a house or a public building, and a small power source for an electronic device.

A conventional PEMFC is generally operated at a temperature lower than 100° C., for example, approximately 80° C., so that the polymer electrolyte membrane does not become too dry. However, due to the low operating temperature, below 100° C., the following problems occur: hydrogen-rich gas, which is a typical fuel for the PEMFC, is obtained by reforming an organic fuel such as a natural gas or methanol, but the hydrogen-rich gas contains both carbon dioxide (CO₂) and carbon monoxide (CO). The CO poisons catalysts associated with the cathodes and anodes within the fuel cell. When such poisoning occurs, electrochemical activity of the catalyst is greatly reduced; and accordingly, the operational efficiency and lifetime of the PEMFC is greatly reduced. As the operating temperature of the fuel cell decreases, the poisoning of the catalyst by the CO becomes more severe.

When the operating temperature of the PEMFC is increased to approximately 130° C. or more, poisoning of the catalyst by CO can be avoided, and the temperature control of the PEMFC becomes easier. With a higher operating temperature, the size of a fuel reformer may be decreased and the need for a more efficient cooling plate is increased. However, a more efficient cooling plate within the fuel cell stack results in the overall decrease of the size of the PEMFC.

FIG. 1 is a perspective view illustrating a structure of a conventional high temperature PEMFC stack, and FIG. 2 is an exploded perspective view illustrating a flow of fluid between a cooling plate and a unit cell.

Referring to FIGS. 1 and 2, a plurality of unit cells 10 are stacked in a PEMFC stack 20. Each unit cell 10 includes an electrolyte membrane 2 and a cathode electrode 1 and an anode electrode 3 disposed on both sides of the electrolyte membrane 2. A separator 4 having flow channels 4a through which an oxidant or hydrogen flows to each electrode is installed between the unit cells 10. A gasket 6 for sealing is installed between the electrode 1 and 3 and the separator 4.

In addition to electricity, heat is generated in the electrochemical reaction process of a fuel cell. As such, a cooling process is needed in order to ensure smooth operation of the fuel cell. A cooling plate 5 and a heat exchanger 30 are installed in the fuel cell stack so as to cool the fuel cell. In the PEMFC stack 20, each cooling plate 5 for exchanging heat is disposed between every few unit cells 10. Cooling water in the cooling plate 5 absorbs heat in the PEMFC stack 20 while passing through flow channels 5a of the cooling plate 5. The heated cooling water is cooled by a secondary cooling water in the heat exchanger 30. Then, the cooling water is circulated back to the PEMFC stack 20.

End plates 21 and 22 are respectively formed on both ends of the PEMFC stack 20. In the end plate 21, a supply hole and a recovery hole for air (oxygen) and a supply hole and a recovery hole for a fuel (hydrogen gas) are formed. And in the end plate 22, a supply hole and recovery hole for cooling water are formed. The above holes are formed in the cooling plate 5, the unit cells 10, and the separator 4. The different holes supply distribute, and discharge the fuels (air, hydrogen gas) and cooling water to each unit cell 10 throughout the PEMFC stack 20.

The cooling water that circulates between the cooling plate 5 and the heat exchanger 30 is a mixture of liquid water and water vapor. And due to the vapor, the pressure in the PEMFC stack 20 rises to about 3 to 5 atmospheres.

A gasket or an O-ring may be installed between the cooling plate 5 and the separator 4 so as to prevent leakage of the cooling water.

However, the gasket or the O-ring hardens due to high temperature, and thus, the sealing effect is reduced as time passes.

### SUMMARY OF THE INVENTION

Aspects of the present invention provide for a sealing structure to be placed between a cooling plate and a separator in a high temperature fuel cell stack that has an improved sealing performance.

According to an aspect of the present invention, there is provided a sealing structure of a cooling plate installed in a unit cell of a fuel cell stack, comprising: grooves respectively formed on complimentary corresponding regions of a separator of the unit cell and the cooling plate on the separator; a first sealing member formed between the grooves; and a plurality of second sealing members formed on each bottom of the grooves.

The first sealing member may be an O-ring formed of a fluoride group rubber.

The second sealing members may be a coating softer than the first sealing member, and may have a hardness of 20 to 40 Hs in JIS hardness specification.

The second sealing member may be a room temperature vulcanizing (RTV) coating.

The second sealing member may have a thickness of 0.1 to 0.2 mm.

According to another aspect of the present invention, there is provided a sealing structure of a cooling plate installed on a unit cell of a fuel cell stack, comprising: a groove formed in at least one region of corresponding regions of a separator of the unit cell and the cooling plate; a first sealing member formed on the groove; and a second sealing member arranged about the first sealing member.

The sealing structure may further comprise a third sealing member on the bottom of the groove.

Additional aspects and/or advantages of the invention will be set forth in part in the description which follows and, in part, will be obvious from the description, or may be learned by practice of the invention.

### BRIEF DESCRIPTION OF THE DRAWINGS

These and/or other aspects and advantages of the invention will become apparent and more readily appreciated from the following description of the embodiments, taken in conjunction with the accompanying drawings of which:

FIG. 1 is a perspective view illustrating a conventional structure of a high temperature polymer electrolyte membrane fuel cell (PEMFC) stack;

FIG. 2 is an exploded perspective view illustrating a flow of fluid between a cooling plate and a unit cell;

FIG. 3 is a cross-sectional view illustrating a sealing structure according to an embodiment of the present invention;

FIG. 4 is a plan view illustrating the cooling plate of FIG. 3;

FIG. 5 is a cross-sectional view illustrating a state when a separator and a cooling plate are combined using the sealing members of FIG. 3;

FIG. 6 is a cross-sectional view illustrating a sealing structure according to another embodiment of the present invention; and

FIG. 7 is a cross-sectional view illustrating a sealing structure according to another embodiment of the present invention.

### DETAILED DESCRIPTION OF THE EMBODIMENTS

Reference will now be made in detail to embodiments of the present invention, examples of which are illustrated in the accompanying drawings, wherein like reference numerals refer to the like elements throughout. The embodiments are described below in order to explain aspects of the present invention by referring to the figures.

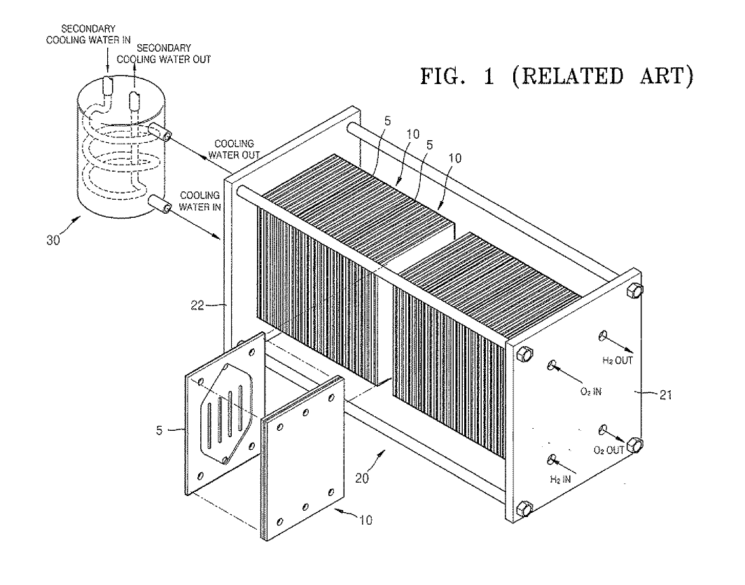

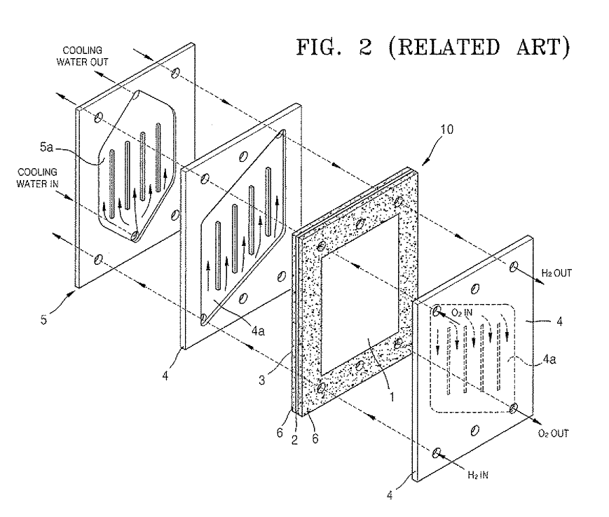

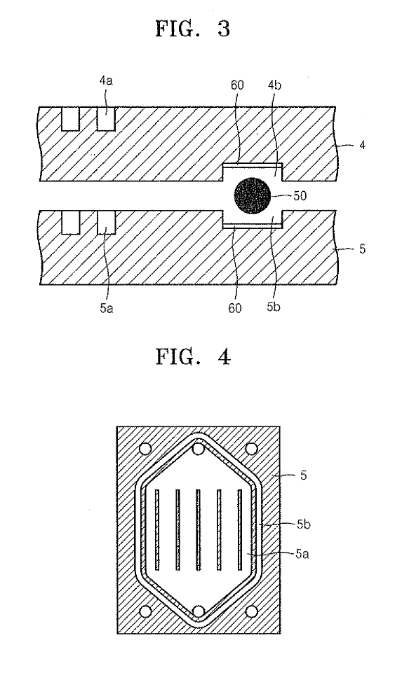

FIG. 3 is a cross-sectional view illustrating a separated sealing structure according to an embodiment of the present invention, and FIG. 4 is a plan view illustrating a cooling plate. Like reference numerals are used to indicate elements that are substantially identical to the elements of FIGS. 1 and 2, and thus the detailed description thereof will not be repeated.

Referring to FIG. 3, grooves 4b and 5b are formed on surfaces of a separator 4 and a cooling plate 5, respectively, which are facing each other. The grooves 4b and 5b, as depicted in FIG. 4, can have a shape that surrounds a region where the flow channels 4a and 5a, respectively, are formed. Although the grooves 4b and 5b are illustrated as rectangular, the grooves 4b and 5b need not be so limited. A second sealing member 60 is formed within each of the grooves 4b and 5b. A first sealing member 50, for example, an O-ring, is installed within the grooves 4b and 5b between the second sealing members 60. The first sealing member 50 may be formed of a thermal resistant material such as a fluoride group rubber. Fluoride group rubbers include polyvinylidene fluoride and silicon fluoride. The second sealing members 60 are formed of a material that is softer than the first sealing member 50.

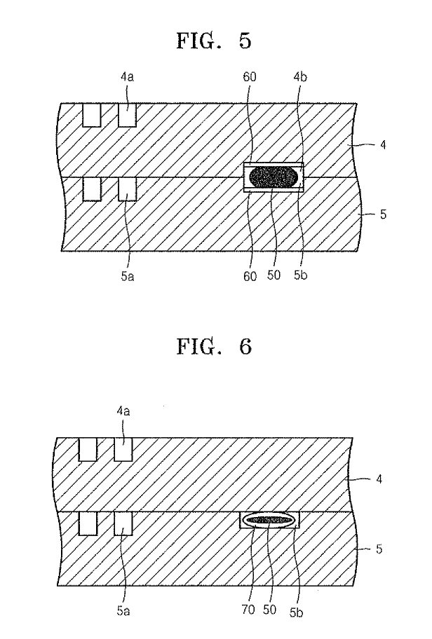

FIG. 5 is a cross-sectional view illustrating a state when the separator 4 and the cooling plate 5 are combined after the first and second sealing members 50 and 60, respectively, of FIG. 3 are installed in the grooves 4b and 5b. The second sealing members 60 are formed on the surfaces of both the grooves 4b and 5b. Upon stacking the separator 4 and the cooling plate 5, the upper and lower surfaces of the first sealing member 50 contact the second sealing members 60 on the groove 4b of the separator 4 and the groove 5b of the cooling plate 5, respectively. For example, when the uncompressed first sealing member 50 has a diameter of 1.9 mm and the depth of each of the grooves 4b and 5b is 0.75 mm, the first sealing member 50 is compressed and transforms into an oval shape as depicted in FIG. 5 when the separator 4 and the cooling plate 5 are combined.

The second sealing members 60 are a coating of a material which is softer than the first sealing member 50. For example, the first sealing member 50, which is formed of a fluoride group rubber, has a hardness of 60 to 80 Hs in the Japanese Industrial Standards (JIS) hardness specification and the second sealing member 60, which is a room temperature vulcanizing (RTV) coating, has a hardness of 20 to 40 Hs in the JIS hardness specification. The second sealing member 60 is soft at room temperature and is thermal resistant (i.e., it maintains its shape at a temperature of 200° C.). Therefore, the second sealing member 60 is stable and can maintain a tight seal at the operating temperature of about 150° C. Such thermal resistance of the second sealing member 60 protects the first sealing member 50 from temperature extremes and helps to prevent failure of the first sealing member 50 due to temperature extremes. Also, the second sealing members 60 can prevent a gas leak caused by rough bottoms of the grooves 4b and 5b.

The second sealing member 60 may be formed to have a thickness of 0.1 to 0.2 mm.

An RTV coating, for example, Dow Corning® 3140 RTV Coating is mixed with toluene in a weight ratio of 1:1 so as to uniformly distribute the RTV coating on the grooves 4b and 5b. The RTV coating mixed with toluene can be applied to the grooves 4b and 5b using a syringe, or any other method of application.

FIG. 6 is a cross-sectional view illustrating a sealing structure according to another embodiment of the present invention. Like reference numerals are used to indicate elements that are substantially identical to the elements of FIG. 3, and thus the detailed description thereof will not be repeated.

Now referring to FIG. 6, a groove 5b is formed only in the cooling plate 5 facing the separator 4. The groove 5b, similar to that depicted in FIG. 4, can have a shape that surrounds a region where the flow channels 5a are formed. A first sealing member 50 and a third sealing member 70 that surrounds the first sealing member 50 are formed and placed in the groove 5b. The shape of the first sealing member 50 becomes an oval shape when the separator 4 and the cooling plate 5 are stacked together.

The third sealing member 70 increases the tightness of the seal between the first sealing member 50 and the surface of the groove 5b and the surface of the separator 4. Thus, the third sealing member 70 increases the sealing performance between the separator 4 and the cooling plate 5.

In FIG. 6, the groove 5b is formed only in the cooling plate 5, but the present invention is not limited thereto. That is, in the same manner as in FIG. 3, a groove corresponding to the groove 5b in the cooling plate 5 can be formed in the separator 4. Also, a groove 4b can be formed solely in the separator 4 instead of forming the groove 5b in the cooling plate 5.

The third sealing member 70 may be formed to a thickness of 0.1 to 0.2 mm.

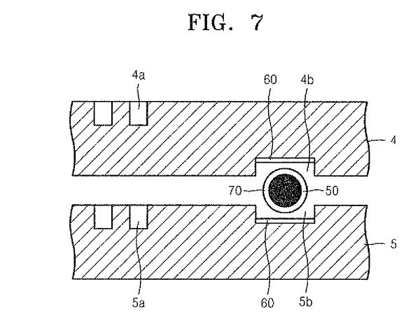

FIG. 7 is a cross-sectional view illustrating a sealing structure according to another embodiment of the present invention. Like reference numerals are used to indicate elements that are substantially identical to the elements of FIGS. 3 and 6, and thus the detailed description thereof will not be repeated.

Referring to FIG. 7, grooves 4b and 5b, again, are formed on surfaces of a separator 4 and a cooling plate 5, respectively, which are facing each other. The grooves 4b and 5b are those as depicted in FIG. 4 and can have a shape that surrounds a region where flow channels 4a and 5a, respectively, are formed. A second sealing member 60 is formed on each of the grooves 4b and 5b. A first sealing member 50, for example an O-ring, and a third sealing member 70 that surrounds the first sealing member 50 are installed between the second sealing members 60. In other embodiments of the current invention, the second sealing member 60 and the third sealing member 70 may be formed differently. For example, the third sealing member 70 may be arranged about the first sealing member 50 in parallel strips or rings. Or, the second sealing member 60 may be arranged on the sides of the grooves 4b and 5b instead of or in addition to along the bottom of the grooves 4b and 5b.

The second and third sealing members 60 and 70 may have a thickness of 0.1 to 0.2 mm.

Sealing characteristics of a sealing structure according to embodiments of the present invention and a conventional sealing structure having an O-ring were tested.

TABLE 1

| Case of sealing structure | Pressure (MPa) | Time (hour) |
|---|---|---|
| conventional | 0.32→0.20 | 1 |
| sealing structure of FIG. 5 | 0.35→0.25 | 68 |
| sealing structure of FIG. 6 | 0.325→0.25 | 18 |
| sealing structure of FIG. 7 | 0.35→0.24 | 168 |

Table 1 summarizes the results of leak tests of a sealing structure according to multiple embodiments of the present invention and a conventional sealing structure. After the flow channels of a cooling plate were filled with nitrogen gas under a pressure of 0.32-0.35 Mpa, pressures were measured over time. For the conventional sealing structure, the time necessary for the pressure to decrease to approximately 0.25 Mpa was within one hour. And, the time necessary for the sealing structure of FIG. 5 to decrease in pressure to 0.25 Mpa was 68 hours. The time necessary for the sealing structure of FIG. 6 to decrease to a pressure of about 0.25 Mpa was 18 hours. Finally, the sealing structure of FIG. 7 did not decrease in pressure to 0.25 Mpa for 168 hours. These results show that the sealing structures according to these embodiments of the present invention have a significantly higher sealing effect than that of the conventional sealing structure.

Table 2 shows estimated leakages of cooling water in a high temperature PEMFC stack associated with the test results of Table 1.

TABLE 2

| Case of sealing | Leakage rate | Time required to | Water supply |
|---|---|---|---|
| structure | (ml/hr) | leak 30 ml (hr) | period |
| Conventional | 3 | 10 | DSS mode |
| sealing structure of | 0.044 | 680 | 28 days |
| FIG. 5 | | | |
| sealing structure of | 0.018 | 1680 | 70 days |
| FIG. 7 | | | |

In a high temperature PEMFC stack having a conventional sealing structure, it was necessary to operate in a daily stop and start (DSS) mode whereby the operation of the stack was stopped for every 30 ml leak of cooling water and restarted after the cooling water was supplemented. However, a high temperature PEMFC stack having the sealing structure according to embodiments of the present invention was able to stably operate for 70 days without stopping.

As described above, a sealing structure of a high temperature PEMFC stack, according to embodiments and aspects of the present invention includes a second sealing member that improves the sealing characteristics while protecting a first sealing member, thereby providing a long term stable sealing structure. Aspects of the current invention demonstrably show increased efficiency of operation as the fuel cell may operate for 70 days without stopping because of water leaking through the seal portion of the fuel cell stack. Aspects of this invention also prevent gas leaks from the fuel cell to the atmosphere as the softer second and third sealing members decrease the effect of rough spots in the construction of the fuel cell which results in the more efficient operation of the fuel cell.

Although a few embodiments of the present invention have been shown and described, it would be appreciated by those skilled in the art that changes may be made in this embodiment without departing from the principles and spirit of the invention, the scope of which is defined in the claims and their equivalents.

What is claimed is:

1. A sealing structure of a cooling plate installed on a unit cell of a fuel cell stack, comprising:
grooves formed in corresponding regions of a separator of the unit cell and the cooling plate on the separator;
a first sealing member formed within the grooves; and
second sealing members respectively formed on the bottom of each of the grooves.

2. The sealing structure of claim 1, wherein the first sealing member is an O-ring formed of a fluoride group rubber.

3. The sealing structure of claim 1, wherein the second sealing members are a coating softer than the first sealing member.

4. The sealing structure of claim 3, wherein the second sealing members have a hardness of 20 to 40 Hs in the JIS hardness specification.

5. The sealing structure of claim 1, wherein the second sealing members are room temperature vulcanizing coatings.

6. The sealing structure of claim 1, wherein the second sealing members have a thickness of 0.1 to 0.2 mm.

7. The sealing structure of claim 1, wherein the second sealing members are formed on the sides and bottoms of the grooves.

8. The sealing structure of claim 1, wherein the grooves are formed to surround flow channels in the separator and the cooling plate.

9. A sealing structure of a cooling plate installed on a unit cell of a fuel cell stack, comprising:
a groove formed in at least one region of corresponding regions of a separator of the unit cell and the cooling plate;
a first sealing member formed in the groove; and
a second sealing member that coats at least portions of the first sealing member.

10. The sealing structure of claim 9, wherein the first sealing member is an O-ring formed of a fluoride group rubber.

11. The sealing structure of claim 9, wherein the second sealing member is a coating softer than the first sealing member.

12. The sealing structure of claim 11, wherein the second sealing member has a hardness of 20 to 40 Hs in the JIS hardness specification.

13. The sealing structure of claim 9, wherein the second sealing member is a room temperature vulcanizing coating.

14. The sealing structure of claim 9, wherein the second sealing member has a thickness of 0.1 to 0.2 mm.

15. The sealing structure of claim 9, further comprising a third sealing member on the bottom of the groove.

16. The sealing structure of claim 15, wherein the third sealing member is a coating softer than the first sealing member.

17. The sealing structure of claim 16, wherein the third sealing member has a hardness of 20 to 40 Hs in the JIS hardness specification.

18. The sealing structure of claim 15, wherein the third sealing member is an room temperature vulcanizing coating.

19. The sealing structure of claim 15, wherein the third sealing member has a thickness of 0.1 to 0.2 mm.

20. The sealing structure of claim 9, wherein the second sealing member completely coats the first sealing member.

21. The sealing structure of claim 15, wherein the third sealing member further comprises a coating on the sides of the groove.

22. The sealing structure of claim 15, wherein the third sealing member also coats the other one region of corresponding regions of a separator of the unit cell and the cooling plate.
